(19) United States
(12) Patent Application Publication
(10) Pub. No.: US 2006/0284841 A1
(43) Pub. Date: Dec. 21, 2006

(54) Apparatus, method, and medium for implementing pointing user interface using signals of light emitters

(75) Inventors: Sun-gi Hong, Hwasung-si (KR); Yong-beom Lee, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/452,992

(22) Filed: Jun. 15, 2006

(30) Foreign Application Priority Data
Jun. 17, 2005 (KR) 10-2005-0052440

(51) Int. Cl. G09G 5/08

(52) U.S. Cl. 345/157

(57) ABSTRACT

An apparatus, method, and medium for implementing a pointing user interface using light emitters are disclosed. The pointing device includes a light-noise removing unit which receives signals emitted from a plurality of light emitters included in a display device in predetermined manners, a light emitter position detecting unit which calculates position information of the received signals, a pointed-to position calculating unit which calculates pointed-to position information using the calculated position information, and a data transmitting unit which transmits the pointed-to position information to the display device.

### CROSS-REFERENCE TO RELATED APPLICATIONS

This application claims priority from Korean Patent Application No.10-2005-0052440 filed on Jun. 17, 2005 in the Korean Intellectual Property Office, the disclosure of which is incorporated herein by reference in its entirety.

### BACKGROUND OF THE INVENTION

1. Field of the Invention

The present invention relates to a pointing user interface, and, more particularly, to an apparatus, method, and medium for implementing a pointing user interface using light emitters.

2. Description of the Related Art

Remote controls are often used to display and select a menu on screens of digital TVs. As a result, there is an increasing demand for graphical user interfaces for use with remote controls. Thus, various types of user interfaces have been suggested to implement digital content management (DCM).

Conventional remote controls allow a user to display a user interface and select a menu or control a function using up/down/left/right direction keys. However, as the amount of content and the number of menus increases in a digital TV, content navigation and menu selection becomes more difficult when using conventional remote controls. Moreover, when a webpage is displayed on a digital TV, it is difficult to navigate on the webpage using only direction keys. To overcome these limitations, research on pointing-based user interfaces has been conducted.

To implement a pointing user interface, a process of calculating a position pointed to by a pointing device (a remote control or a pointer) and an apparatus for providing a user interface is required.

Korean Patent Publication No. 2003-46093 discloses a technique for detecting a position pointed to (pointed-to position) on a screen or a TV using a camera or an optical sensor. The technique includes several steps that a laser pointer is used to mark a certain position on a TV screen at first. Then pushing a key on the remote control enables an infrared signal to be pointed at the same position and sensing this infrared signal performs to compute its position. However, to use this technique, pointing using a laser and infrared light is required and noise may be added to a pointing signal due to another light emitter. Korean Patent Publication No. 2004-98173 discloses a method of calculating a pointing position on a screen by generating a predetermined signal at the edges of the screen and sensing the edges of the screen using a remote control. However, the method also has a difficulty in determining the edges of the screen due to external light.

Therefore, it is useful for a pointing device to have an apparatus and/or method for computing a pointing position although there are external noises such as light variation, daylight reflection, and so on.

### SUMMARY OF THE INVENTION

Additional aspects, features, and/or advantages of the invention will be set forth in part in the description which follows and, in part, will be apparent from the description, or may be learned by practice of the invention.

The present invention provides an apparatus, method, and medium for implementing a pointing user interface using light emitters, where the pointing performance is not affected by external noises such as light variation, light reflections, and so on.

The above aspects, features and advantages, of the present invention will become clear to those skilled in the art upon review of the following description.

According to an aspect of the present invention, there is provided a pointing device comprising a light emitter noise removing unit which receives signals emitted from a plurality of light emitters included in a display device in predetermined manners, a light emitter position detecting unit which calculates position information of the received signals, a pointed-to position calculating unit which calculates pointed-to position information using the calculated position information, and a data transmitting unit which transmits the pointed-to position information to the display device.

According to another aspect of the present invention, there is provided a device comprising a light emitting unit which emits signals in predetermined manners to a pointing device using a plurality of light emitters, a data receiving unit which receives position information of the signals received by the pointing device and information about a position pointed to by the pointing device from the pointing device, a pointed-to position calculating unit which calculates the information about the pointed-to position using the received position information, and a display control unit which changes output data according to the information about the pointed-to position.

According to still another aspect of the present invention, there is provided a method of implementing a pointing user interface using light emitters, the method comprising receiving signals emitted from a plurality of light emitters included in a display device in predetermined manners, calculating pointed-to position information using position information of the received signals, and transmitting the pointed-to position information to the display device.

According to a further aspect of the present invention, there is provided a method of implementing a pointing user interface using light emitters, the method comprises emitting signals using a plurality of light emitters in predetermined manners to a pointing device, receiving position information of the signals received by the pointing device and information about a position pointed to by the pointing device from the pointing device, calculating the information about the pointed-to position using the received position information, and changing output data according to the information about the pointed-to position.

According to another aspect of the present invention, there is provided a pointing device comprising a light emitter noise removing unit which receives signals emitted from a plurality of light emitters included in a display device, wherein the signals have one or more predetermined frequencies and wherein the reception of the signals is predetermined to be simultaneous or sequential; a light emitter position detecting unit which calculates position information of the received signals; a pointed-to position calculating unit which calculates pointed-to position information using the calculated position information; and a data transmitting unit which transmits the pointed-to position information to the display device.

According to another aspect of the present invention, there is provided a device comprising a light emitter emitting unit which emits signals to a pointing device using a plurality of light emitters, wherein the signals have one or more predetermined frequencies and wherein the transmission of the signals is predetermined to be simultaneous or sequential; a data receiving unit which receives position information of the signals received by the pointing device and information about a position pointed to by the pointing device from the pointing device; a pointed-to position calculating unit which calculates the information about the pointed-to position using the received position information; and a display control unit which changes output data according to the information about the pointed-to position.

According to another aspect of the present invention, there is provided a method of implementing a pointing user interface using light emitters, comprising receiving signals emitted from a plurality of light emitters included in a display device, wherein the signals have one or more predetermined frequencies and wherein the reception of the signals is predetermined to be simultaneous or sequential; calculating pointed-to position information using position information of the received signals; and transmitting the pointed-to position information to the display device.

According to another aspect of the present invention, there is provided a method of implementing a pointing user interface using light emitters, comprising emitting signals using a plurality of light emitters to a pointing device, wherein the signals have one or more predetermined frequencies and wherein the emission of the signals is predetermined to be simultaneous or sequential; receiving position information of the signals received by the pointing device and information about a position pointed to by the pointing device from the pointing device; calculating the information about the pointed-to position using the received position information; and changing output data according to the information about the pointed-to position.

According to another aspect of the present invention, there is provided at least one computer readable medium storing executable instructions that control at least one processor to perform the methods of the present invention.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a pointing principle according to an exemplary embodiment of the present invention;

FIG. 2 illustrates the inter-working between a remote control that removes noise and receives signals of light emitters and a display device according to an exemplary embodiment of the present invention;

FIG. 3 illustrates a process of obtaining a pointed-to position of a remote control according to an exemplary embodiment of the present invention;

FIG. 4 illustrates coordinates obtained through a homography matrix according to an exemplary embodiment of the present invention;

FIG. 5 is a side view of a 2-dimensional position sensitive detector (2D PSD) sensor according to an exemplary embodiment of the present invention;

FIG. 6 shows a front view and a perspective view of the 2D PSD sensor of FIG. 5;

FIG. 7 illustrates components of a remote control and a display device according to an exemplary embodiment of the present invention;

FIG. 8 illustrates components of a remote control and a display device according to an exemplary embodiment of the present invention;

FIG. 9 illustrates a remote control and a display device according to an exemplary embodiment of the present invention;

FIG. 10 illustrates components of a remote control and a display device according to an exemplary embodiment of the present invention;

FIG. 11 illustrates a remote control and a projector screen according to an exemplary embodiment of the present invention;

FIG. 12 is a flowchart illustrating a process used by a remote control to implement a pointing user interface according to an exemplary embodiment of the present invention; and

FIG. 13 is a flowchart illustrating a process used by a display device or a pointing receiving device to implement a pointing user interface according to an exemplary embodiment of the present invention.

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

The present invention is described hereinafter with reference to flowchart illustrations of an apparatus and method of implementing a pointing user interface using light emitters according to exemplary embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, implement the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture to implement the function specified in the flowchart block or blocks. The computer program instructions may also be loaded into a computer or other programmable data processing apparatus to cause a series of operational steps to be performed in the computer or other programmable apparatus to produce a computer implemented process such that the instructions that execute on the computer or other programmable apparatus provide steps for implementing the functions specified in the flowchart block or blocks.

And each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

In addition, exemplary embodiments of the present invention can also be implemented by executing computer readable code/instructions in/on a medium, e.g., a computer readable medium. The medium can correspond to any medium/media permitting the storing and/or transmission of the computer readable code.

The computer readable code/instructions can be recorded/transferred in/on a medium in a variety of ways, with examples of the medium including magnetic storage media (e.g., floppy disks, hard disks, magnetic tapes, etc.), optical recording media (e.g., CD-ROMs, or DVDs), magneto-optical media (e.g., floptical disks), hardware storage devices (e.g., read only memory media, random access memory media, flash memories, etc.) and storage/transmission media such as carrier waves transmitting signals, which may include instructions, data structures, etc. Examples of storage/transmission media may include wired and/or wireless transmission (such as transmission through the Internet). Examples of wired storage/transmission media may include optical wires and metallic wires. The medium/media may also be a distributed network, so that the computer readable code/instructions is stored/transferred and executed in a distributed fashion. The computer readable code/instructions may be executed by one or more processors.

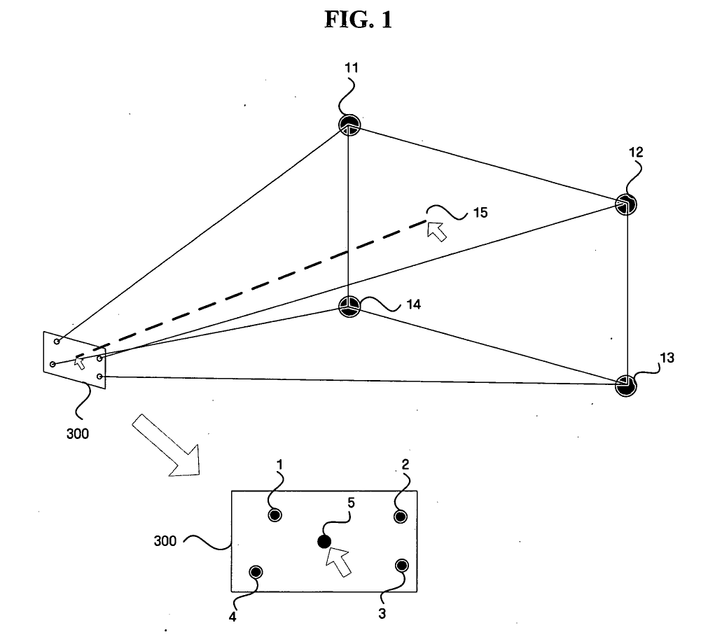

FIG. 1 illustrates a pointing principle according to an exemplary embodiment of the present invention. In FIG. 1, light emitters 11, 12, 13, and 14 emit signals such as infrared rays and visible rays. A sensor 300 that receives signals emitted from the light emitters 11, 12, 13, and 14 mounted at corners of a display device can sense positions 1, 2, 3, and 4 of the light emitters 11, 12, 13, and 14. To prevent interferences between the light emitters 11, 12, 13, and 14 and other lights (lighting, fluorescent lights, lights from TVs, and other signals), each of the light emitters 11, 12, 13, and 14 emits a signal in a previously agreed manner. For example, the light emitter 11 emits a signal in manner A, the light emitter 12 emits a signal in manner B, the light emitter 13 emits a signal in manner C, and the light emitter 14 emits a signal in manner D. When the signal emission manners are previously agreed with the sensor 300, the sensor 300 can determine from which light emitter a received signal is emitted. Thus, the signal emission manners may be previously stored in the sensor 300 or the sensor 300 and the display device may exchange data to determine the manners according to a predetermined mechanism.

A position 15 pointed by the sensor 300 corresponds to a center 5 of the sensor 300. The center 5 of the sensor 300 can be calculated without using a predetermined signal. As a result, when a matrix H for transforming the sensed positions 1, 2, 3, and 4 of the light emitters 11, 12, 13, and 14 into actual positions of the light emitters 11, 12, 13, and 14 is calculated, the position 15 can be calculated using the matrix H and the center 5 of the sensor 300.

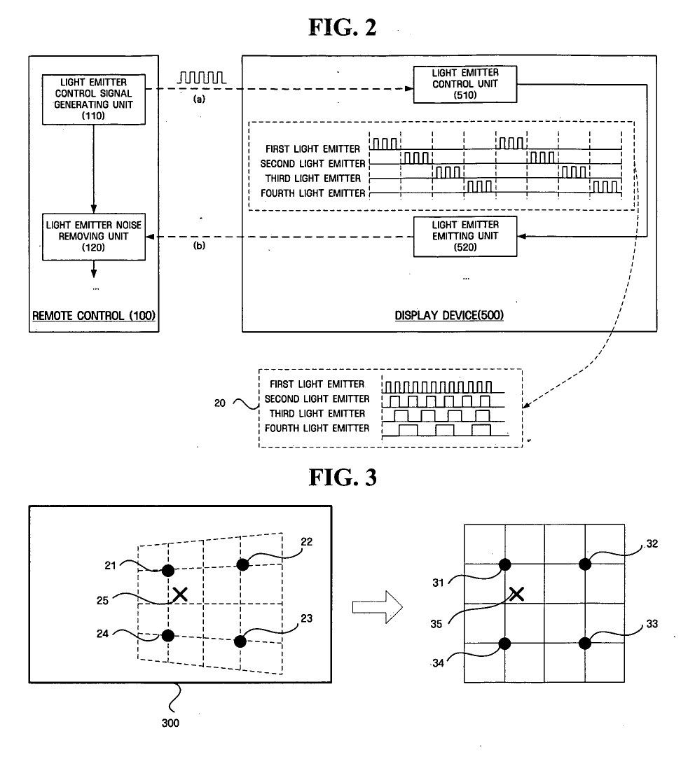

FIG. 2 illustrates the inter-working between a remote control 100 that removes noise and receives signals of light emitters and a display device 500 according to an exemplary embodiment of the present invention.

In FIG. 1, in order to sense the light emitters 11, 12, 13, and 14 to prevent interferences generated by other lighting or other devices, signals are transmitted in the previously agreed manners A, B, C, and D. For example, if the remote control 100 transmits a previously agreed transmission manner of a signal to be received, as indicated by a dotted arrow labeled a, which will be referred to as operation (a), the display device 500 sequentially transmits the signal. A light emitter control signal generating unit 110 of the remote control 100 transmits a signal having a predetermined frequency to the display device 500. A light emitter control unit 510 transmits a signal having the same frequency as the received signal through a light emitting unit 520. When there is a plurality of light emitters and the light emitters emit signals have the same frequency, it may be difficult to determine from which light emitter a received signal is emitted. Thus, as shown in FIG. 2, the plurality of light emitters may sequentially emit signals having the same frequency. A first light emitter emits a signal having the same frequency as the received signal. After emission of the first light emitter, a second light emitter, a third light emitter, and then a fourth light emitter sequentially emit signals having the same frequency as the received signal. As a result, as indicated by a dotted arrow labeled b, which will be referred to as operation (b), a light emitter noise removing unit 120 of the remote control 100 sequentially receives the signals having the same frequency as the signal transmitted in operation (a) and calculates the center 5 of the sensor 300 based on the sensed positions of the first through fourth light emitters.

In FIG. 2, the remote control 100 transmits a signal having a predetermined frequency and the display device 500 sequentially emits signals having the same frequency as the received signal. However, if the remote control 100 transmits a signal having a frequency A, the light emitters of the display device 500 may simultaneously emit signals, each having a frequency of ½ or ¼ of A (frequency). For example, when the remote control 100 transmits a signal of 10 Hz, the first light emitter may emit a signal of 10 Hz, the second light emitter may emit a signal of 5 Hz, the third light emitter may emit a signal of 2.5 Hz, and the fourth light emitter may emit a signal of 1.25 Hz, as indicated by 20. Since signals having difference frequencies are emitted from the light emitters, the sensor 300 can determine from which light emitter a received signal is emitted. In addition, the remote control 100 can previously calculate ½, ¼, and ⅛ of a frequency of the signal transmitted as in operation (a), and noise can be removed separately from other signals. In this case, the light emitters may also sequentially signals for clearer distinguishment between the signals.

In FIG. 2, the remote control 100 may be a remote control of a digital TV (DTV), a digital versatile disc (DVD), or a projector. Also, a gun for shooting games may also be considered as a remote control.

FIG. 3 illustrates a process of obtaining a pointing position of a remote control according to an exemplary embodiment of the present invention.

The sensor 300 senses signals from light emitters. A center 25 of the sensor 300 is a reference point for pointing of the sensor 300. Positions of the light emitters sensed by the sensor 300 are 21, 22, 23, and 24. When the sensed positions 21, 22, 23, and 24 of the light emitters are transformed into actual positions of the light emitters mounted in a display device, it can be determined a position at which the display device the center 25 of the sensor 300 points. Thus, by obtaining a matrix for transforming the sensed positions 21, 22, 23, and 24 into actual positions 31, 32, 33, and 34 and applying the obtained matrix to the center 25 of the sensor 300, a position 35 pointed by the center 25 of the sensor 300 within the actual positions 31, 32, 33, and 34 can be obtained.

Homography may be used to transmit the sensed positions 21, 22, 23, and 24 into the actual positions 31, 32, 33, and 34. Homography indicates a correlation between points in a plane and points in another plane. In the present invention, the actual positions of the light emitters and the sensed positions of the light emitters become points in different planes and a relationship therebetween is defined using a homography matrix.

As shown in FIG. 3, let 3-dimensional (3D) coordinates P₂₁ of the sensed position 21 be (x₂, y₂, z₂) and 3D coordinates P₃₁ of the actual position 31 be (x₁, y₁, z₁). A relationship between the two points P₂₁ and P₃₁ is as follows:

$$( \begin{matrix}{x}_{2} \\ {y}_{2} \\ {z}_{2}\end{matrix} ) = ( \begin{matrix}{H}_{11} & {H}_{12} & {H}_{13} \\ {H}_{21} & {H}_{22} & {H}_{23} \\ {H}_{31} & {H}_{32} & {H}_{33}\end{matrix} ) ( \begin{matrix}{x}_{1} \\ {y}_{1} \\ {z}_{1}\end{matrix} ) \qquad ( 1 )$$

Since the light emitters are actually located in the same plane, a signal received with respect to the z-axis can be transformed with respect to the z-axis. Adjustment with respect to the z-axis (x′₂=x₂/z₂,y′₂=y₂/z₂) can be performed as follows:

$${x}_{2}^{′} = \frac{{H}_{11} {x}_{1} + {H}_{12} {y}_{1} + {H}_{13} {z}_{1}}{{H}_{31} {x}_{1} + {H}_{32} {y}_{1} + {H}_{33} {z}_{1}} \\ {y}_{2}^{′} = \frac{{H}_{21} {x}_{1} + {H}_{22} {y}_{1} + {H}_{23} {z}_{1}}{{H}_{31} {x}_{1} + {H}_{32} {y}_{1} + {H}_{33} {z}_{1}} \qquad ( 2 )$$

The light emitters mounted in the display device are located at the same position with respect to the z-axis. Thus, when z₁=1 through adjustment with respect to the z-axis, a result can be obtained as follows:
x′₂(H₃₁x₁+H₃₂y₁+H₃₃)=H₁₁x₁+H₁₂y₁+H₁₃
y′₂(H₃₁x₁+H₃₂y₁+H₃₃)=H₂₁x₁+H₂₂y₁+H₂₃ (3)

As mentioned above, (x₁, y₁) indicates coordinates of a light emitter in a TV and (x′₂, y′₂) indicates coordinates of the light source sensed by the sensor 300. The sensor 300 previously has information about (x₁, y₁) of light emitters of the display device and also recognizes (x′₂, y′₂) . When there are a total of four light emitters, Equation 3 may be used for each of the light emitters and the matrix H can be obtained using a total of 8 equations.

When the coordinates of the center 25 of the sensor 300 are (CX₂, CY₂) and the coordinates of the position 35 pointed by the center 25 of the sensor 300 are (CX₁, CY₁), (CX₁, CY₁) can be obtained using the matrix H.

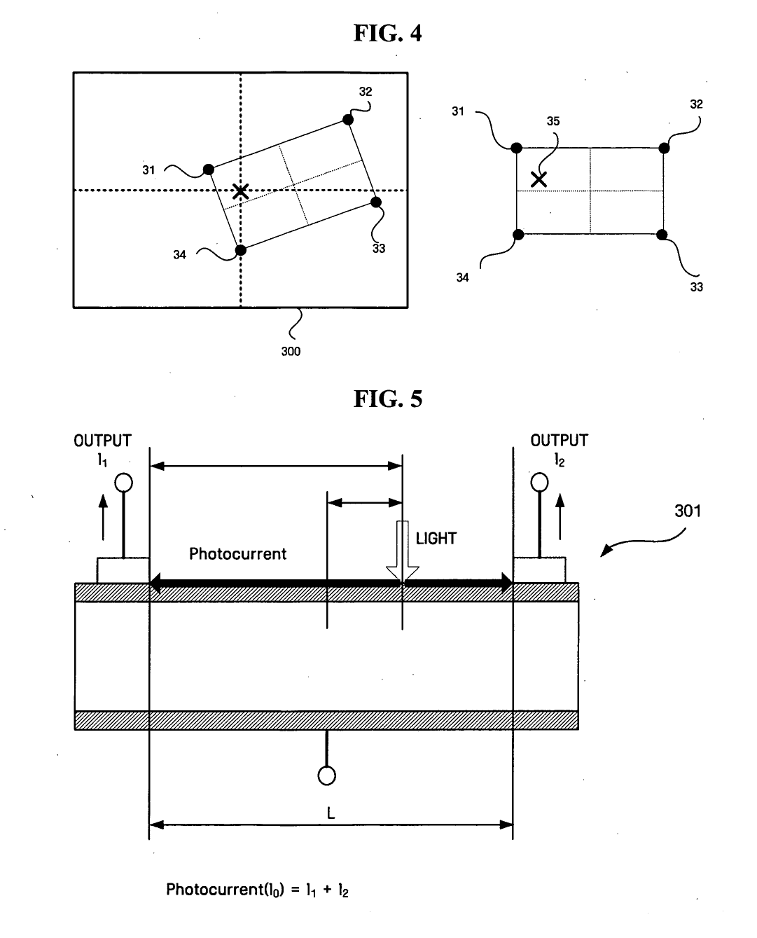

FIG. 4 illustrates coordinates obtained through a homography matrix according to an exemplary embodiment of the present invention. Position information of the light emitters of the display device can be obtained using the homography matrix, thus calculating the position 35 pointed by the center 25 of the sensor 300.

When the positions of the light emitters are sensed in FIGS. 3 and 4, the sensor 300 can determine from which light emitter a received signal is emitted through sequential transmission or transmission in previously agreed manners as in FIG. 2.

FIG. 5 is a side view of a 2-dimensional position sensitive detector (2D PSD) sensor according to an exemplary embodiment of the present invention. A 2-dimensional position sensitive detector (2D PSD) sensor senses light signals of various wavelengths, such as infrared rays and ultraviolet rays, according to its material and its current changes according to the sensed position of a light signal. The 2D PSD determines the actual position of the light signal using a change in the amount of current.

In FIG. 5, a PSD 301 senses light and a change in the amount of current of the sensed position of light. A 2D PSD sensor senses a change in the amount of current sensed with respect to the X axis and the Y axis to detect a 2D incident position of light. A charged coupled device (CCD) sensor senses and calculates the maximum of the amount of light for each pixel.

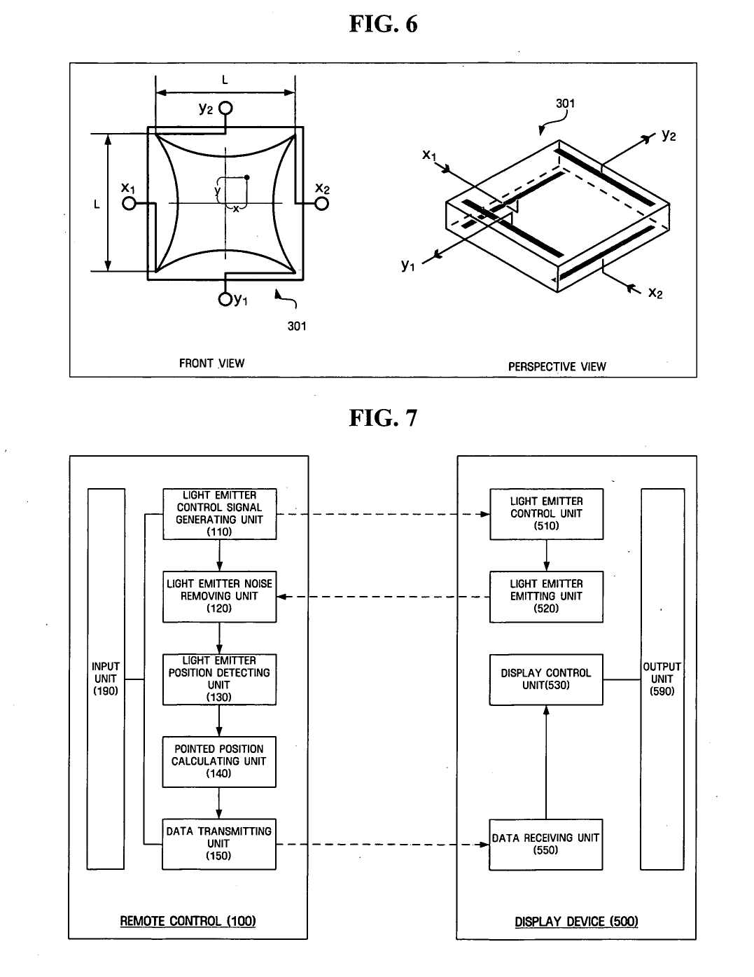

FIG. 6 shows a front view and a perspective view of the 2D PSD sensor 301 of FIG. 5. The incident position of light is calculated by calculating the X-axis position of incident light between x₁ and x₂ and the Y-axis position of incident light between y₁ and y₂. L indicates the length of one side of the 2D PSD sensor 301.

$$\frac{( {x}_{2} + {y}_{1} ) - ( {x}_{1} + {y}_{2} )}{{x}_{1} + {x}_{2} + {y}_{1} + {y}_{2}} = \frac{2 x}{L} \\ \frac{( {x}_{2} + {y}_{2} ) - ( {x}_{1} + {y}_{1} )}{{x}_{1} + {x}_{2} + {y}_{1} + {y}_{2}} = \frac{2 y}{L} \qquad ( 4 )$$

As can be appreciated from Equation 4, a change in the amount of current when light is incident can be obtained using x₁, x₂, y₁, and y₂ and the x and y coordinates of the incident position of light can be calculated by substituting L into the obtained change in the amount of current.

When a PSD sensor is used, the amount of power consumption can be reduced when compared to using a conventional video camera. In general, a CCD sensor consumes 250mW or more and a PSD sensor consumes 3 Mw. However, in the present invention, a light emitter sensor is not limited to a PSD sensor, but may be another sensor such as a CCD sensor or a CMOS (complementary metal oxide semiconductor field effect transistor) sensor. When a PSD sensor is used, a point light emitter may be used to improve sensing efficiency.

In the present invention, the term “unit”, “part” or “module” used herein indicates a software component or a hardware component such as a field-programmable gate array (FPGA) or an application-specific integrated circuit (ASIC). The unit performs a particular function but is not restricted to software and hardware. The unit may be included in an addressable storage medium or may be configured to play one or more processors. Accordingly, units may include components such as software components, object-oriented software components, class components, and task components, processes, functions, attributes, procedures, subroutines, segments of a program code, drivers, firmware, microcodes, circuits, data, databases, data structures, tables, arrays, and parameters. Components and features provided by units may be combined into a smaller number of components and a smaller number of units, or may be divided into a greater number of components and a greater number of units. In addition, components and units may be implemented such that they play one or more central processing units (CPUs) in a device or a secure MMC.

FIG. 7 illustrates components of a remote control and a display device according to an exemplary embodiment of the present invention.

The remote control 100 includes the light emitter control signal generating unit 110, the light emitter noise removing unit 120, a light emitter position detecting unit 130, a pointed-to position calculating unit 140, a data transmitting unit 150, and an input unit 190.

The light emitter control signal generating unit 110 requests light emitters mounted in the display device 500 to emit signals for calculation of positions pointed by the light emitters. At this time, to remove noise, the light emitter control signal generating unit 110 may request the light emitters to emit signals of previously agreed frequencies. The light emitter control signal generating unit 110 may transmit information about signals, such as frequencies of the signals to be emitted from the light emitters. In addition, the light emitter control signal generating unit 110 may also transmit information about whether the light emitters sequentially or simultaneously emit the signals, together with the information about the signals. The signal emission manners and the characteristic of signals (frequencies) may be previously agreed between the remote control 100 and the display device 500 and then stored in the light control signal generating unit 110.

The light emitter noise removing unit 120 senses signals emitted from the light emitters of the display device 500. Here, the light emitter noise removing unit 120 obtains information about the signal emission manners or the characteristic of the signals from the light emitter control signal generating unit 110, removes noise from the received signals, and selects the signals emitted from the display device 500. Thus, a signal generated in the screen of the display device 500 or noise generated from surrounding lighting or other electric appliances can be removed.

The light emitter position detecting unit 130 detects position information of the light emitters received after noise is removed therefrom by the light emitter noise removing unit 120. At this time, a PSD sensor, a CCD sensor, or a CMOS sensor may be used.

The pointed-to position calculating unit 140 can obtain a displacement using the position information detected by the light emitter position detecting unit 130 and the positions of the light emitters mounted in the display device 500. To obtain the displacement, the homograph matrix as in FIGS. 3 and 4 may be used. The obtained displacement is applied to the center of the sensor 300. Thus, by obtaining a relative displacement with respect to the previously detected positions of the light emitters, a position in the screen of the display device 500 pointed by the center of the sensor 300 can be determined. The data transmitting unit 150 transmits information about the pointed-to position to a data receiving unit 550 of the display device 500. The display device 500 displays a pointing action or performs a previously agreed operation corresponding to the pointing action according to the received information.

The data transmitting unit 150 of the remote control 100 and the data receiving unit 550 of the display device 500 may use various communication methods, such as infrared communication, radio frequency (RF) communication, or wired commutation. Thus, the communication method is not limited to methods of light signal emission and reception between the remote control 100 and the display device 500.

The input unit 190 is implemented as buttons or a touch panel in the remote control 100. By pressing a button of the input unit 190 while pointing at a specific position with the remote control 100, a menu displayed in the pointed-to position or a specific function can be implemented. In addition, the input unit 190 can also be driven by an automatically executed program or hardware. When the input unit 190 transmits an input signal for activating pointing to the light emitter control signal generating unit 110, the light emitter control signal generating unit 110 may request the display device 500 to emit signals for pointing. According to another exemplary embodiment of the present invention, the light emitter control signal generating unit 110 may request the display device 500 to emit signals for pointing continuously for a predetermined period of time without the input signal being transmitted from the input unit 190. Such exemplary embodiments may vary with signal emission methods and power supply of the remote control 100.

The sensor 300 in FIGS. 3 and 4 includes the light emitter noise removing unit 120 and may also includes both the light emitter position detecting unit 130 and the light emitter noise removing unit 120.

The display device 500 includes a light emitter control unit 510, a light emitter emitting unit 520, a display control unit 530, a data receiving unit 550, and an output unit 590. The light emitter control unit 510 controls the light emitter emitting unit 520 to emit signals according to the control signal transmitted from the light emitter control signal generating unit 110. The light emitter control unit 510 controls the light emitter emitting unit 520 to emits signals having previously agreed frequencies or signals having frequencies that are predetermined by the light emitter control signal generating unit 110. The light emitter control unit 510 may also control sequential or simultaneous signal emission of the light emitters.

The light emitter emitting unit 520 emits signals under the control of the light emitter control unit 510. The light emitter emitting unit 520 may emit various signals for detecting a screen region, such as infrared rays, visible rays, or ultraviolet rays.

Once the light emitter noise removing unit 120 of the remote control 100 receives the signals emitted from the light emitter emitting unit 520 and the pointed-to position calculating unit 140 calculates a pointed-to position and transmits the pointed-to position through the data transmitting unit 150, the data receiving unit 550 receives position information and transmits the received position information to the display control unit 530. The display control unit 530 controls information output to the output unit 590. The display control unit 530 controls screen information or menu information such that a displayed menu is implemented at the pointed-to position or selection of a specific menu is indicated according to a currently displayed screen or menu. The pointed-to position may also be marked. By marking the pointed-to position with an arrow, a user can easily recognize the pointed-to position

The output unit 590 generally refers to a unit that outputs a screen in a monitor or a TV. The output unit 590 may be a conventional CRT, a plasma display panel (PDP), a liquid crystal display (LCD), an organic electroluminescence (EL), or other display devices.

The light emitter control unit 510 of the display device 500 can receive information transmitted from the light emitter control signal generating unit 110 of the remote control 100 through the data receiving unit 550.

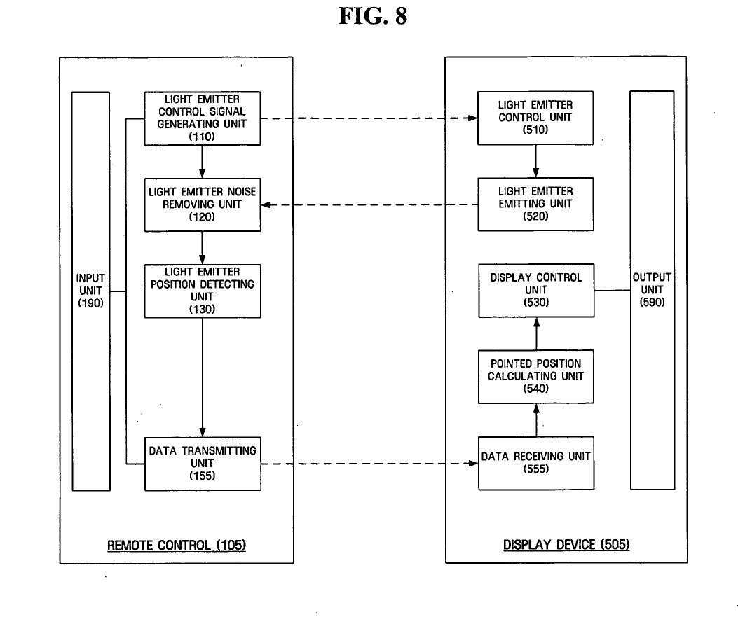

FIG. 8 illustrates components of a remote control and a display device according to an exemplary embodiment of the present invention. In FIG. 8, a pointed-to position calculating unit is included in a display device unlike in FIG. 7.

The configuration of a remote control 105 is similar to that of the remote control 100 of FIG. 7 except that the remote control unit 150 does not include the pointed-to position calculating unit 140.

The remote control 105 includes the light emitter control signal generating unit 110, the light emitter noise removing unit 120, the light emitter position detecting unit 130, a data transmitting unit 155, and the input unit 190.

Since the light emitter control signal generating unit 110, the light emitter noise removing unit 120, the light emitter position detecting unit 130, and the input unit 190 function in the same way as those in FIG. 7, a detailed description thereof will not be provided.

Unlike the data transmitting unit 150 of FIG. 7, the data transmitting unit 155 transmits position information detected by the light emitter position detecting unit 130 and information about the pointed-to position to a data receiving unit 555 of the display device 505. The data receiving unit 555 transmits the position information and the information about the pointed-to position to the pointed-to position calculating unit 540.

The data transmitting unit 155 of the remote control 105 and the data receiving unit 555 of the display device 505 may use various communication methods, such as infrared communication, radio frequency (RF) communication, or wired commutation. Thus, the communication method is not limited to methods of light signal emission and reception between the remote control 105 and the display device 505.

The sensor 300 in FIGS. 3 and 4 includes the light emitter noise removing unit 120 and may also include both the light emitter position detecting unit 130 and the light emitter noise removing unit 120.

The configuration of the display device 505 is similar to that of the display device 500 of FIG. 7 except that the display device 505 further includes a pointed-to position calculating unit 540. The display device 505 includes the light emitter control unit 510, the light emitter emitting unit 520, the display control unit 530, the pointed-to position calculating unit 540, and the data receiving unit 550. Since the light emitter control unit 510, the pointed-to position calculating unit 540, and the data receiving unit 550, function in the same way as those in FIG. 7, a detailed description thereof will not be provided.

The data receiving unit 555 receives sensed position information of light emitters and position information of the center of the sensor through the data transmitting unit 155. A displacement can be obtained through the sensed position information of the light emitters and actual position information of the light emitters. The displacement may be obtained using the homography matrix in FIGS. 3 and 4. The obtained displacement is applied to the center of the sensor. Thus, by obtaining a relative displacement with respect to the previously detected positions of the light emitters, a position in the screen of the display device 505 pointed by the center of the sensor can be obtained. The information about the pointed-to position calculated by the pointed-to position calculating unit 540 is transmitted to the display control unit 530, and the display control unit 530 performs controlling such that a specific menu is implemented or the pointed-to position is marked with an arrow.

The output unit 590 generally refers to a unit that outputs a screen in a monitor or a TV. The output unit 590 may be a conventional CRT, a plasma display panel (PDP), a liquid crystal display (LCD), an organic electroluminescence (EL), or other display devices.

The light emitter control unit 510 of the display device 500 can receive information transmitted from the light emitter control signal generating unit 110 of the remote control 100 through the data receiving unit 555.

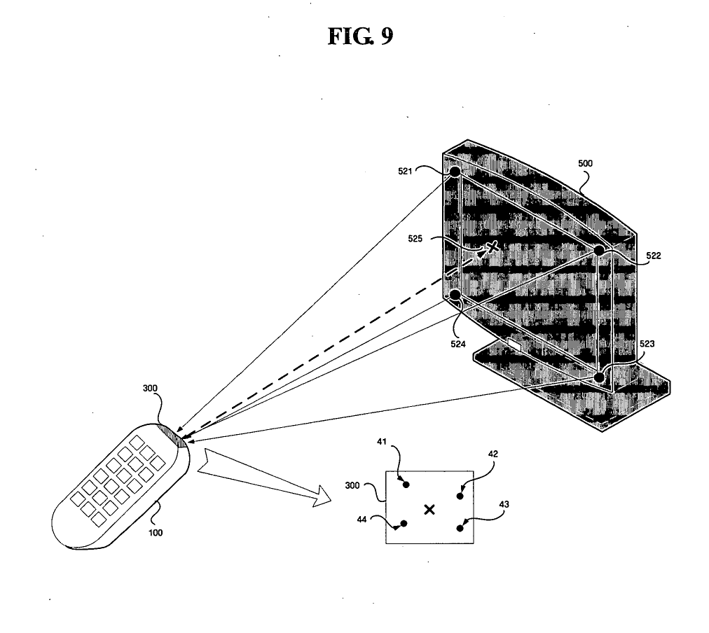

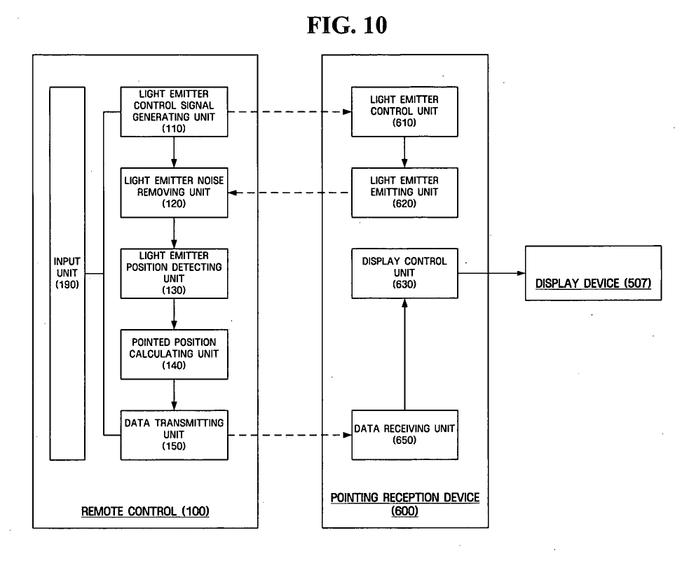

FIG. 9 illustrates a remote control and a display device according to an exemplary embodiment of the present invention. Four light emitters 521, 522, 523, and 524 are mounted in the display device 500. The sensor 300 of the remote control 100 senses signals from the light emitters 521, 522, 523, and 524. A position 525 pointed by the center of the remote control 100 is calculated by a pointed-to position calculating unit. The positions 41, 42, 43, and 44 of the light emitters 521, 522, 523, and 524 are sensed by the sensor 300 of the remote control 100. The pointed-to position calculating unit may be included in the remote control 100 or the display device 500.

FIG. 10 illustrates components of a remote control and a display device according to an exemplary embodiment of the present invention. In FIGS. 8 and 9, the display device 500 emits signals to the remote control 100. In FIG. 10, the configuration of a pointing receiving device 600 that can be mounted in the display device 500 and the configuration of the remote control 100 are shown. A user can use a pointing function of the remote control 100 using the pointing receiving device 600 regardless of the display device 500.

The configuration of the remote control 100 is shown in FIG. 8. The remote control 105 of FIG. 9 may also be used. Functions performed by the remote control 100 and data transmitted and received by the remote control 100 are already described with reference to FIG. 8 or 9.

The pointing receiving device 600 emits signals for calculating a pointed-to position to the remote control 100. Like the light emitter control unit 510 of the display device 500 or 505, a light emitter control unit 610 controls a light emitter emitting unit 620 to emit signals in a manner agreed with the remote control 100. The light emitter emitting unit 620 outputs signals under control of the light emitter control unit 610. The detailed descriptions of the light emitter control unit 610 and the light emitter emitting unit 620 are the same with the descriptions of the light emitter control unit 510 and the light emitter emitting unit 520 of FIGS. 8 and 9.

The remote control 100 analyzes a received signal. Such an analysis can be performed by the pointed-to position calculating unit 140 that obtains a displacement between a sensed position of a light emitter and an actual position of the light emitter using homograph calculation in FIGS. 3 and 4. Once the sensor calculates the pointed-to position and transmits the pointed-to position to the data transmitting unit 150, the data transmitting unit 150 transmits the pointed-to position to the pointing receiving device 600. A data receiving unit 650 of the pointing receiving device 600 transmits data transmitted by the data transmitting unit 150 of the remote control 100 to a display control unit 630 The display control unit 630 performs controlling such that the pointed-to position is indicated on the display device 507 according to information about the pointed-to position.

As shown in FIG. 9, a pointed-to position calculating unit for calculating the pointed-to position may be included in the pointing receiving device 600.

Referring to FIG. 10, the display device 507 may be effectively used as a pointing device using light emitters mounted at corners of the display device 507 even when a separate pointing device is not provided. In particular, the display device 507 may be mounted in a DTV or a projector to which light emitters are not included.

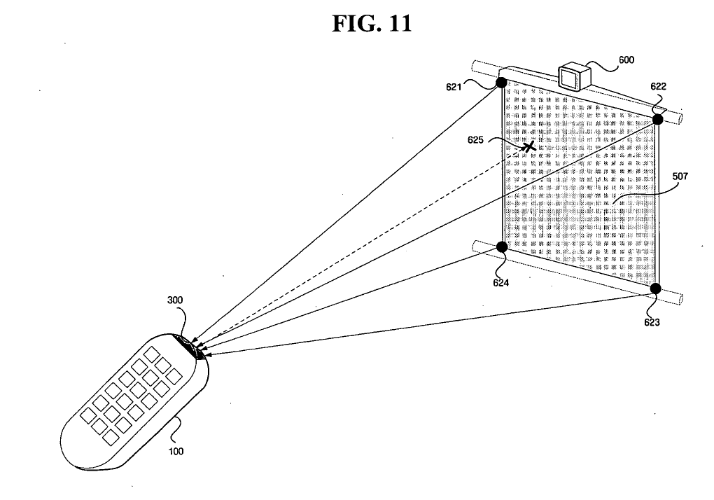

FIG. 11 illustrates a remote control and a projector screen according to an exemplary embodiment of the present invention. The remote control 100 calculates a pointed-to position 625 according to signals emitted from light emitter emitting units 621, 622, 623, and 624 of the pointing receiving device 600 mounted at corners of a projector screen 507 that shows display information of a projector (not shown). The remote control 100 transmits a calculation result to the pointing receiving device 600. The pointing receiving device 600 transmits the pointed-to position to the projector (not shown) to indicate the pointed-to position on the projector screen 507.

The light emitter emitting units 520 and 620 in FIGS. 7, 8, and 10 can emit signals using infrared signals, laser signals, and visible-ray signals.

Although a remote control for a TV or a projector is used as an example in FIGS. 9 and 11, the present invention can also be applied to various fields in addition to remote controls. For example, for arms used in games, such as a gun used in a gun-shooting game, pointing is supported only in a CRT TV. However, according to an exemplary embodiment of the present invention, pointing can also be applied using an LCD, a PDP, an organic EL, a field emission display (FED), or a projector. In addition, pointing can be directly performed using a remote control on a computer monitor. When a specific position is pointed by a laser pointer, information about a pointed-to position can be transmitted to a display device, instead of simply indicating a pointed menu. Moreover, the apparatus according to the present invention can also be added to a sighting controller like in a shooting simulation for transmitting position information. The apparatus or method according to the present invention transmits pointing information about a specific position and can be applied to a remote control, a shooting controller, and a pointer. Thus, a pointing device includes all the devices described above.

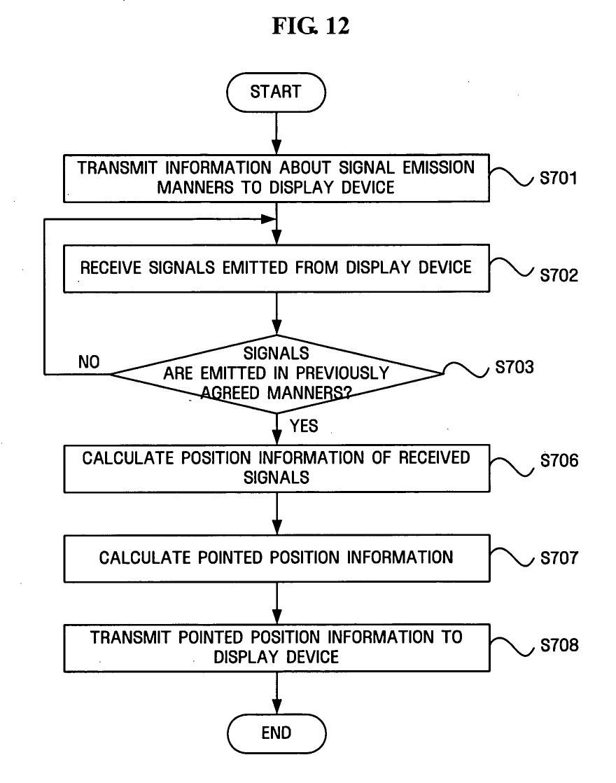

FIG. 12 is a flowchart illustrating a process used by a remote control to implement a pointing user interface according to an exemplary embodiment of the present invention.

Information about a signal emission manner is transmitted to a display device in step S701. The signal emission manner includes the characteristic of a signal (frequency) to be emitted and sequential or simultaneous emission. The display device receives the emitted signal in step S702. A remote control checks if the received signal are emitted in previously agreed manners in step S703 to distinguish the signal emitted from the display device for pointing from surrounding light or signals generated from other devices. In this way, noise can be removed. If the received signal is not emitted in the previously agreed manners, the display device receives the emitted signal again in step S703. When the received signal is emitted in the previously agreed manners, position information of the received signal is calculated in step S706. Since the actual position of a light emitter emitting the signal is known, a matrix for transformation between the actual position and the sensed position of the light emitter can be obtained. Pointed-to information is calculated using the obtained matrix in step S707. The pointed-to position information is transmitted to the display device in step S708. Thus, the display device can indicate the pointed-to position with a cursor or implement a menu displayed on the pointed-to position.

The pointing device includes a device for pointing at a portion of a displayed area, such as a remote control, a pointer, and a sighting device in a shooting game or a shooting simulation.

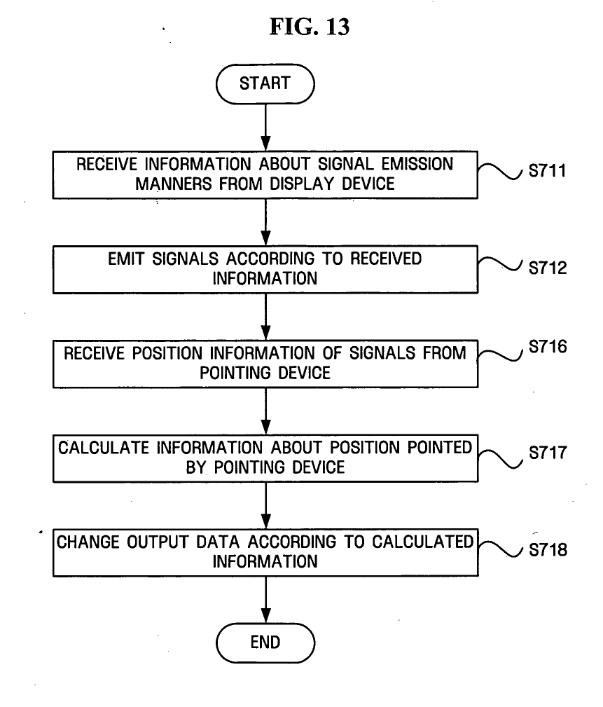

FIG. 13 is a flowchart illustrating a process used by a display device or a pointing receiving device to implement a pointing user interface according to an exemplary embodiment of the present invention. Information about a signal emission manner is received from the pointing device in step S711. The signal emission manner includes the characteristic of a signal (frequency) to be emitted and sequential or simultaneous emission. A signal is emitted in a manner previously agreed with the pointing device in step S712. The pointing device receives the emitted signal and calculates and transmits position information, and the calculated position information is received in step S716. A matrix obtaining the actual position and from the sensed position of the light emitter is obtained. Information about the position pointed by the pointing device is calculated using the obtained matrix in step S717. Output data is changed according to the information in step S718. Changing the output data means outputting an image such as a cursor for pointing on an output screen or activating a menu screen displayed on the pointed-to position.

The pointing device includes a device for pointing at a portion of a displayed area, such as a remote control, a pointer, or a sighting device in a shooting game or a shooting simulation.

Thus, according to the present invention, a pointing user interface can be implemented using only a light emitter.

In addition, since a signal is emitted in a predetermined manner, noise can be removed to prevent the signal of the light emitter from being distorted by lighting or signals from other devices.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. A pointing device comprising:
a light emitter noise removing unit which receives signals emitted from a plurality of light emitters included in a display device in predetermined manners;
a light emitter position detecting unit which calculates position information of the received signals;
a pointed-to position calculating unit which calculates pointed-to position information using the calculated position information; and
a data transmitting unit which transmits the pointed-to position information to the display device.

2. The pointing device of claim 1, further comprising a light emitter control signal generating unit which transmits information about the signal emission manners to the display device.

3. The pointing device of claim 1, wherein the signal emission manners include a manner in which signals having previously agreed frequencies are emitted.

4. The pointing device of claim 1, wherein the position information is information about the center of the light emitter noise removing unit.

5. The pointing device of claim 1, wherein the light emitter noise removing unit receives signals that are sequentially emitted from the plurality of light emitters.

6. The pointing device of claim 1, wherein the pointed-to position calculating unit calculates positions of the light emitters using the received signals, calculates a matrix for transforming the calculated positions of the light emitters into actual positions of the light emitters, and calculates pointed-to position information using the matrix.

7. The pointing device of claim 1, wherein the light emitter noise removing unit includes one of a 2-dimensional position sensitive detector (2D PSD) sensor, a complementary metal-oxide-semiconductor (CMOS) sensor, and a charged coupled device (CCD) sensor.

8. The pointing device of claim 1, wherein when the light emitter noise removing unit is a 2D PSD, the light emitters are point light emitters.

9. The pointing device of claim 1, wherein the pointing device is one of a remote control, a gun-shooting controller, and a pointer indicating a pointed-to position on an output device.

10. A device comprising:
a light emitter emitting unit Which emits signals in predetermined manners to a pointing device using a plurality of light emitters;
a data receiving unit which receives position information of the signals received by the pointing device and information about a position pointed to by the pointing device from the pointing device;
a pointed-to position calculating unit which calculates the information about the pointed-to position using the received position information; and
a display control unit which changes output data according to the information about the pointed-to position.

11. The device of claim 10, further comprising a light emitter control unit which receives information about the signal emission manners from the pointing device and controls the light emitter emitting unit to emit the signals in the signal emission manners.

12. The device of claim 10, wherein the signal emission manners include a manner in which signals having predetermined frequencies are emitted.

13. The device of claim 10, wherein a light emitting unit emits signals sequentially from a plurality of light emitters.

14. The device of claim 10, wherein the pointed-to position calculating unit calculates a matrix for transforming the position information received by the data receiving unit into the actual positions of the light emitters and calculates the information about the position pointed to by the pointing device using the matrix.

15. The device of claim 10, wherein the display control unit changes the output data such that the pointing of the pointing device is indicated at the pointed-to position calculated by the pointed-to position calculating unit.

16. A method of implementing a pointing user interface using light emitters, comprising:
receiving signals emitted from a plurality of light emitters included in a display device in predetermined manners;
calculating pointed-to position information using position information of the received signals; and
transmitting the pointed-to position information to the display device.

17. The method of claim 16, further comprising transmitting information about signal emission manners to the display device.

18. The method of claim 16, wherein the signal emission manners include a manner in which signals having predetermined frequencies are emitted.

19. The method of claim 16, wherein the position information is information about the center of the light-noise removing unit.

20. The method of claim 16, wherein the receiving of the signals comprises receiving signals that are sequentially emitted from the plurality of light emitters.

21. The method of claim 16, wherein the calculating of the pointed-to position information comprises:
calculating positions of the light emitters using the received signals;
calculating a matrix for transforming the calculated positions of the light emitters into actual positions of the light emitters; and
calculating pointed-to position information by using the matrix.

22. A method of implementing a pointing user interface using light emitters, comprising:
emitting signals using a plurality of light emitters in predetermined manners to a pointing device;
receiving position information of the signals received by the pointing device and information about a position pointed to by the pointing device from the pointing device;
calculating the information about the pointed-to position using the received position information; and
changing output data according to the information about the pointed-to position.

23. The method of claim 22, further comprising receiving information about the signal emission manners from the pointing device.

24. The method of claim 22, wherein the signal emission manners include a manner in which signals having predetermined frequencies are emitted.

25. The method of claim 22, wherein the emitting of the signals includes emitting signals sequentially from the plurality of light emitters.

26. The method of claim 22, wherein the calculating of the pointed-to position information comprises:
calculating positions of the light emitters using the received signals;
calculating a matrix for transforming the calculated positions of the light emitters into actual positions of the light emitters; and
calculating pointed-to position information using the matrix.

27. The method of claim 22, wherein the changing of the pointed-to position information includes:
changing output data such that pointing of the pointing device is indicated in the pointed-to position calculated according to the information about the pointed-to position.

28. The method of claim 22, wherein the pointing device is one of a remote control, a gun-shooting controller, and a pointer indicating a pointed-to position on an output device.

29. At least one computer readable medium storing executable instructions that control at least one processor to perform the method of claim 16.

30. At least one computer readable medium storing executable instructions that control at least one processor to perform the method of claim 22.

31. A pointing device comprising:
a light emitter noise removing unit which receives signals emitted from a plurality of light emitters included in a display device, wherein the signals have one or more predetermined frequencies and wherein the reception of the signals is predetermined to be simultaneous or sequential;
a light emitter position detecting unit which calculates position information of the received signals;
a pointed-to position calculating unit which calculates pointed-to position information using the calculated position information; and
a data transmitting unit which transmits the pointed-to position information to the display device.

32. A device comprising:
a light emitter emitting unit which emits signals to a pointing device using a plurality of light emitters, wherein the signals have one or more predetermined frequencies and wherein the transmission of the signals is predetermined to be simultaneous or sequential;
a data receiving unit which receives position information of the signals received by the pointing device and information about a position pointed to by the pointing device from the pointing device;
a pointed-to position calculating unit which calculates the information about the pointed-to position using the received position information; and
a display control unit which changes output data according to the information about the pointed-to position.

33. A method of implementing a pointing user interface using light emitters, comprising:
receiving signals emitted from a plurality of light emitters included in a display device, wherein the signals have one or more predetermined frequencies and wherein the reception of the signals is predetermined to be simultaneous or sequential;
calculating pointed-to position information using position information of the received signals; and
transmitting the pointed-to position information to the display device.

34. A method of implementing a pointing user interface using light emitters, comprising:
emitting signals using a plurality of light emitters to a pointing device, wherein the signals have one or more predetermined frequencies and wherein the emission of the signals is predetermined to be simultaneous or sequential;
receiving position information of the signals received by the pointing device and information about a position pointed to by the pointing device from the pointing device;
calculating the information about the pointed-to position using the received position information; and
changing output data according to the information about the pointed-to position.

35. At least one computer readable medium storing executable instructions that control at least one processor to perform the method of claim 33.

36. At least one computer readable medium storing executable instructions that control at least one processor to perform the method of claim 34.
